(19) United States
(12) Patent Application Publication
(10) Pub. No.: US 2012/0253796 A1
(43) Pub. Date: Oct. 4, 2012

(54) SPEECH INPUT DEVICE, METHOD AND PROGRAM, AND COMMUNICATION APPARATUS

(75) Inventor: Taichi MAJIMA, Tokyo-To (JP)

(73) Assignee: JVC KENWOOD Corporation a corporation of Japan, Yokohama-Shi (JP)

(21) Appl. No.: 13/434,271

(22) Filed: Mar. 29, 2012

(30) Foreign Application Priority Data
Mar. 31, 2011 (JP) 2011-077980

(51) Int. Cl. G10L 11/06

(52) U.S. Cl. 704/214; 704/E11.007

(57) ABSTRACT

A sound is picked up by a microphone. A speech waveform signal is generated based on the picked up sound. A speech segment or a non-speech segment is detected based on the speech waveform signal. The speech segment corresponds to a voice input period during which a voice is input. The non-speech segment corresponds to a non-voice input period during which no voice is input. A determination signal is generated that indicates whether the picked up sound is the speech segment or the non-speech segment. A detected state of the speech segment is indicated based on the determination signal.

### CROSS-REFERENCE TO RELATED APPLICATIONS

This application is based on and claims the benefit of priority from the prior Japanese Patent Application No. 2011-077980 filed on Mar. 31, 2011, the entire content of which is incorporated herein by reference.

### BACKGROUND OF THE INVENTION

The present invention relates to a speech input device, a speech input method, a speech input program, and a communication apparatus.

Wireless communication apparatuses for professional use are used in a variety of environments, such as, an environment with much noise. For use in an environment with much noise, some types of wireless communication apparatus for professional use is equipped with a microphone having a noise cancelling function to maintain a high speech communication quality.

There are a single-microphone type and a dual-microphone type for noise cancellation. The single-microphone type uses a single microphone to receive a sound and convert the sound into a signal that is then separated into a speech component and a noise component for suppression of the noise component. The dual-microphone type uses a voice pick-up microphone for picking up voices and a noise pick-up microphone for picking up noises. A noise component carried by the output signal of the voice pick-up microphone is suppressed using the output signal of the noise pick-up microphone.

Different from mobile phones for ordinary use, some types of wireless communication apparatus for professional use are equipped with a position-adjustable microphone with respect to the main body of the communication apparatus. Such a position-adjustable microphone, however, could cause the variation in a voice pick-up state among users due to the difference, among the users, in location of a microphone or in way of holding the microphone. In order to maintain a good voice pick-up state, it is required for users to hold a microphone at an appropriate position. Guidance on the use of wireless communication apparatuses for professional use has been provided, however, not enough for letting users hold a microphone at an appropriate position.

Some types of wireless communication apparatus for professional use allow a user to use a microphone while the microphone is being attached to the user's chest or shoulder, for example. In such types, it is also difficult for the wireless communication apparatus to pick up the user's voice at an appropriate level or in a good voice pick-up state if a microphone is not held at an appropriate position.

### SUMMARY OF THE INVENTION

A purpose of the present invention is to provide a speech input device, a speech input method, a speech input program, and a communication apparatus that inform a user of the current voice pick-up state.

The present invention provides a speech input device comprising: a first sound pick-up unit configured to pick up a sound and outputting a first speech waveform signal based on the picked up sound; a speech-segment determination unit configured to detect a speech segment corresponding to a voice input period during which a voice is input or a non-speech segment corresponding to a non-voice input period during which no voice is input, based on the first speech waveform signal and to output a determination signal that indicates whether the picked up sound is the speech segment or the non-speech segment; and an indicating unit configured to indicate a detected state of the speech segment based on the determination signal.

Moreover, the present invention provides a speech input method comprising the steps of: picking up a sound;

generating a first speech waveform signal based on the picked up sound; detecting a speech segment corresponding to a voice input period during which a voice is input or a non-speech segment corresponding to a non-voice input period during which no voice is input, based on the first waveform signal; generating a determination signal that indicates whether the picked up sound is the speech segment or the non-speech segment; and indicating a detected state of the speech segment based on the determination signal.

Furthermore, the present invention provides a control speech input program stored in a non-transitory computer readable storage medium, comprising: a program code of picking up a sound; a program code of generating a first speech waveform signal based on the picked up sound; a program code of detecting a speech segment corresponding to a voice input period during which a voice is input or a non-speech segment corresponding to a non-voice input period during which no voice is input, based on the first speech waveform signal; a program code of generating a determination signal that indicates whether the picked up sound is the speech segment or the non-speech segment; and a program code of indicating a detected state of the speech segment based on the determination signal.

Moreover, the present invention provides a communication apparatus comprising: a first sound pick-up unit configured to pick up a sound and outputting a speech waveform signal; a transmission unit configured to transmit the speech waveform signal; a speech-segment determination unit configured to detect a speech segment corresponding to a voice input period during which a voice is input or a non-speech segment corresponding to a non-voice input period during which no voice is input, based on the speech waveform signal and to output a determination signal that indicates whether the picked up sound is the speech segment or the non-speech segment; and an indicating unit configured to indicate a detected state of the speech segment based on the determination signal.

### BRIEF DESCRIPTION OF DRAWINGS

FIG. 1 is a schematic illustration of a wireless communication apparatus for professional use equipped with a speech input device, an embodiment according to the present invention;

FIG. 2 is a schematic block diagram of an embodiment of a speech input device according to the present invention;

FIG. 3 is a schematic block diagram of a digital signal processor installed in the speech input device shown in FIG. 2;

FIG. 4 is a schematic timing chart showing an operation of the speech input device shown in FIG. 2, with an illustration of a speech waveform signal;

FIG. 5 is a schematic timing chart that showing an operation of the speech input device shown in FIG. 2, with an illustration of a speech waveform signal;

FIG. 6 is a schematic block diagram of a first modification to the digital signal processor shown in FIG. 3;

FIG. 7 is a view showing an operation of the first modification shown in FIG. 6;

FIG. 8 is a schematic timing chart showing an operation of the first modification shown in FIG. 6, with an illustration of speech waveform signals;

FIG. 9 is a schematic timing chart showing an operation of the first modification shown in FIG. 6, with an illustration of speech waveform signals;

FIG. 10 is a schematic timing chart showing an operation of the first modification shown in FIG. 6, with an illustration of speech waveform signals;

FIG. 11 is a schematic flow chart showing an operation of the first modification shown in FIG. 6;

FIG. 12 is a schematic block diagram of a second modification to the digital signal processor shown in FIG. 3;

FIG. 13 is a view showing an operation of the second modification shown in FIG. 12;

FIG. 14 is a schematic timing chart showing an operation of the second modification shown in FIG. 12, with an illustration of speech waveform signals;

FIG. 15 is a schematic timing chart showing an operation of the second modification shown in FIG. 12, with an illustration of speech waveform signals;

FIG. 16 is a schematic timing chart showing an operation of the second modification shown in FIG. 12, with an illustration of speech waveform signals; and

FIG. 17 is a schematic flow chart showing an operation of the second modification shown in FIG. 12.

### DETAILED DESCRIPTION OF PREFERRED EMBODIMENTS

Embodiments of a speech input device, a speech input method, a speech input program, and a communication apparatus according the present invention will be explained with reference to the attached drawings. The same or analogous elements are given the same reference numerals or signs throughout the drawings, with the duplicated explanation thereof omitted.

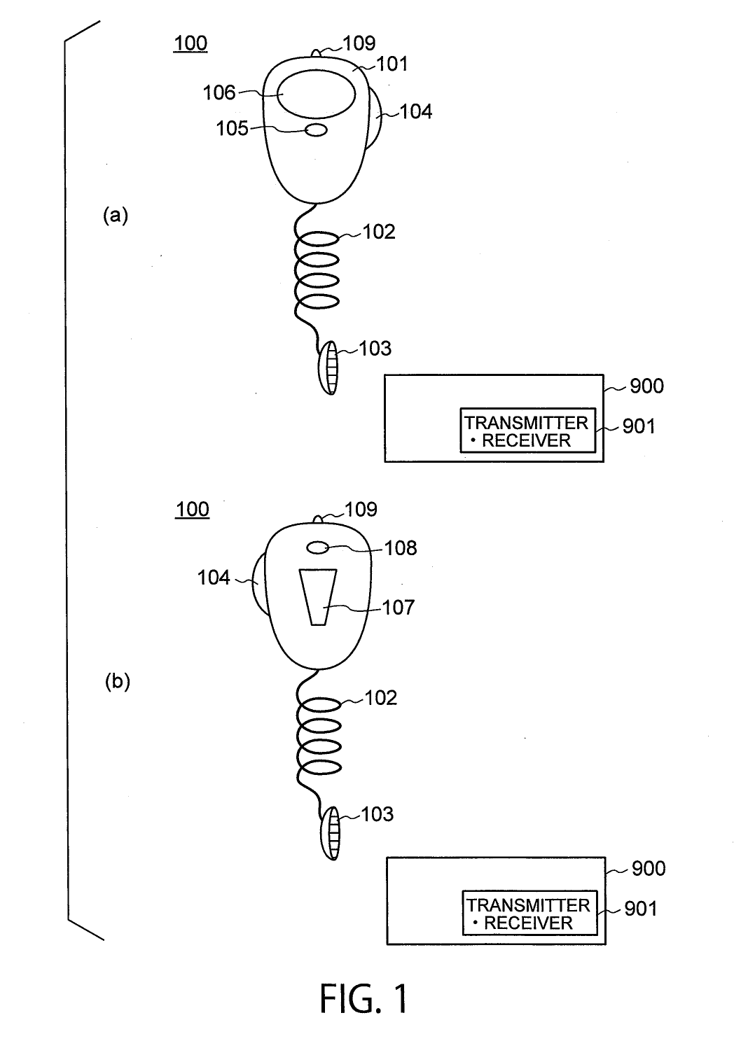

As shown in FIGS. 1 to 3, a speech input device 100 is provided with (as main elements): a voice pick-up microphone 10 for picking up sounds especially voices that are generated when a user speaks into the microphone 10; a speech-segment determination unit 31 for detecting a speech segment corresponding to a voice input period during which the user's voice is input to the speech input device 100 or a non-speech segment corresponding to a non-voice input period during which no user's voice is input to the speech input device 100, based on a speech waveform signal output from the microphone 10 and for outputting a determination signal Sig_RD that indicates whether the picked up sound is the speech segment or the non-speech segment; and an indicating (informing) unit (an LED driver 33 and an LED 50) for indicating (informing) the user of a detected state of the speech segment based on the output of the speech-segment determination unit 31.

The speech-segment determination unit 31 detects a speech segment that corresponds to a voice input period during which a user's voice is input to the speech input device 100 and a non-speech segment that corresponds to a non-voice input period during which no user's voice is input to the speech input device 100, based on a waveform signal output from the voice pick-up microphone 10. The LED driver 33 drives the LED 50 in response to the output of the speech-segment determination unit 31 so that the LED 50 is turned on or off to inform a user of a detection state of the user's voice at the speech input device 100.

With the turn-on or -off of the LED 50, a user can know whether the location of the microphone 10 is appropriate and place the microphone 10 at an appropriate location if a speech detection state at the speech input device 100 is not good. Although depending on the situation, a user can know that the user's voice is not reaching the voice pick-up microphone 10 in a good condition and get rid of the obstacle. For example, when the microphone 10 is located at the user's chest or shoulder, the user's clothes could become the obstacle to the user's voice. In such a case, the speech input device 100 informs the user of a speech detection state with the turn-on or -off of the LED 50 so that the user can get rid of the obstacle.

The speech-segment determination unit 31 uses a technique called VAD (Voice Activity Detection) to determine that an incoming sound is a user's voice or not. With this technique, it is possible to detect a user's speech picked up state while noises other than human voices are suppressed. This feature is advantageous particularly for a wireless communication apparatus for professional use to be used in a noisy environment. Without the voice determination, that is, with the detection of an incoming sound level only (with noises included), it is not suitable for a wireless communication apparatus for professional use to be used in a noisy environment.

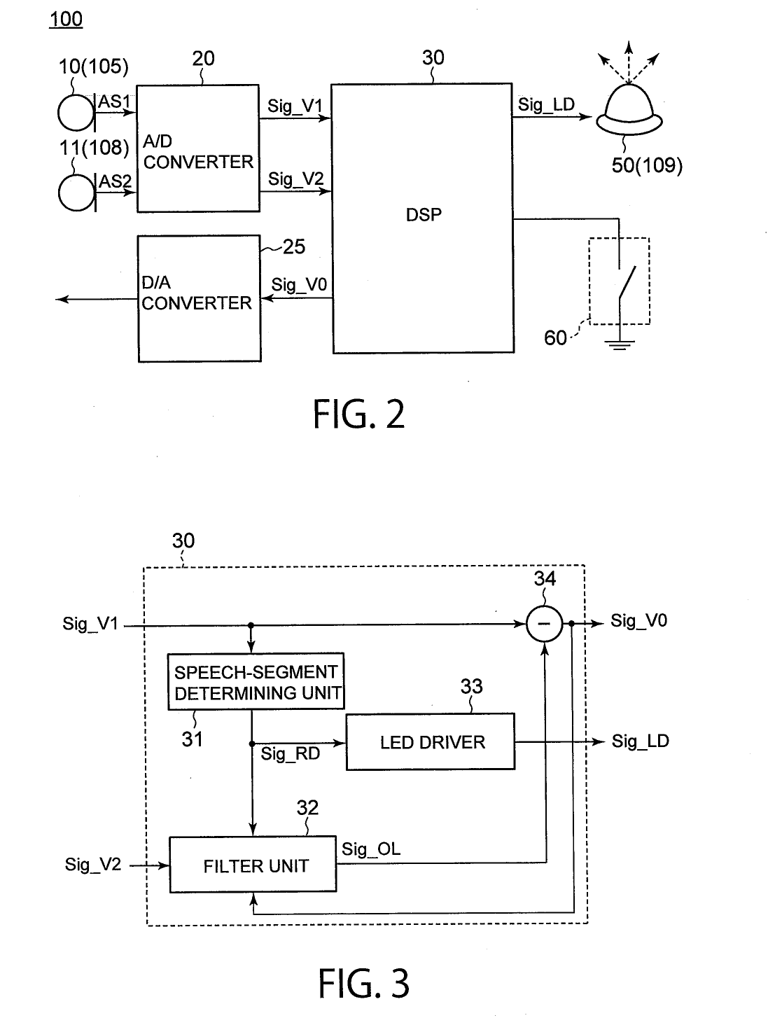

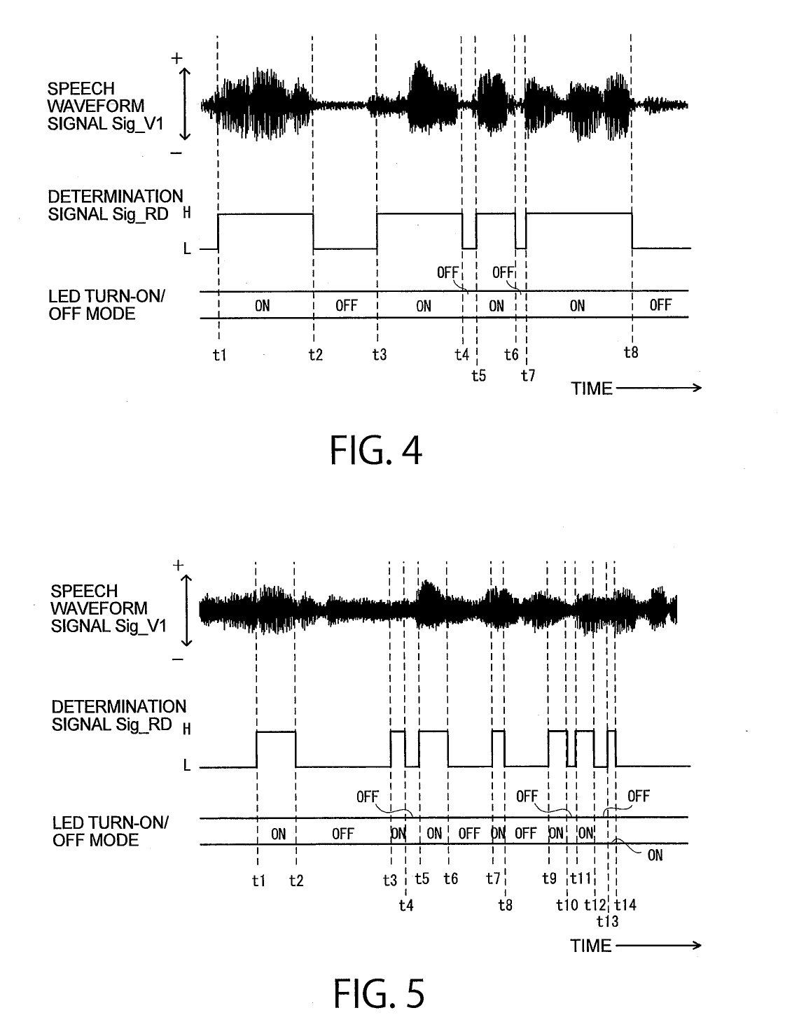

The speech input device 100 will be described in detail with respect to FIGS. 1 to 5. FIG. 1 is a schematic illustration of a wireless communication apparatus 900 for professional use equipped with the speech input device 100, with views (a) and (b) showing the front and rear sides of the speech input device 100, respectively. FIG. 2 is a schematic block diagram of the speech input device 100. FIG. 3 is a schematic block diagram a DSP (Digital Signal Processor) 30. FIGS. 4 and 5 are schematic timing charts indicating an operation of the speech input device 100.

As shown in FIG. 1, the speech input device 100 is detachably connected to the wireless communication apparatus 900. The wireless communication apparatus 900 is equipped with a transmission and reception unit 901 for use in wireless communication at a specific frequency. When a user speaks, the user's voice is picked up by the wireless communication apparatus 900 via the speech input device 100 and a speech signal is transmitted from the transmission and reception unit 901. A speech signal transmitted from another wireless communication apparatus is received by the transmission and reception unit 901 of the wireless communication apparatus 900.

The speech input device 100 has a main body 101 equipped with a cord 102 and a connector 103. The main body 101 is formed having a specific size and shape so that a user can grab it with no difficulty. The main body 101 houses several types of parts, such as, a microphone, a speaker, an LED (Light Emitting Diode), a switch, an electronic circuit, and mechanical elements. The main body 101 is assembled with these parts installed therein. The main body 101 is electrically connected to the wireless communication apparatus 900 through the cord 102 that is a cable having wires for transferring a speech signal, a control signal, etc. The connector 103 is a general type of connector and mated with another connector attached to the wireless communication apparatus 900. For example, a power is supplied to the speech input device 100 from the wireless communication apparatus 900 through the cord 102.

As shown in the view (a) of FIG. 1, a microphone 105 for picking up voices and a speaker 106 are provided at the front side of the main body 101. Provided at the rear side of the main body 101 are a belt clip 107 and a microphone 108 for picking up noises, as shown in the view (b) of FIG. 1. Provided at the top and the side of the main body 101 are an LED 109 and a PTT (Push To Talk) unit 104, respectively. The LED 109 informs a user of the user's voice pick-up state detected by the speech input device 100. The PTT unit 104 has a switch that is pushed into the main body 101 to switch the wireless communication apparatus 900 into a speech transmission state. The configuration of the speech input device 100 is not necessary limited to that shown in FIG. 1.

As shown in FIG. 2, the speech input device 100 is provided with the voice pick-up microphone 10, a noise pick-up microphone 11, an A/D converter 20, a D/A converter 25, a DSP 30, an LED 50, and a transistor 60. The voice pick-up microphone 10 corresponds to the voice pick-up microphone 105 shown in FIG. 1, that is a first sound pick-up unit for picking up a sound especially a user's voice. The noise pick-up microphone 11 corresponds to the noise pick-up microphone 108 shown in FIG. 1, that is a second sound pick-up unit for picking up a sound especially noises generated around the user the source of sound). The reference numerals 105 and 108 will be used for the voice pick-up microphone and the noise pick-up microphone, respectively, when the location of the microphones are discussed, hereinafter. The LED 50 corresponds to the LED 109 shown in FIG. 1. The transistor 60 corresponds to the PTT unit 104 shown in FIG. 1, with a switch to be pushed into the main body 101 in order for the transistor 60 to be turned on. The DSP is implemented with a semiconductor chip, such as, a multi-functional ASIC (Application Specific Integrated Circuit).

As shown in FIG. 2, the outputs of the microphones 10 and 11 are connected to the A/D converter 20. The outputs of the A/D converter 20 are connected to the DSP 30. The outputs of the DSP 30 are connected to the LED 50 and the D/A converter 25. The transistor 60 is connected between the DSP 30 and the ground.

The microphones 10 and 11 output analog speech waveform signals AS1 and AS2, respectively, that are converted into digital speech waveform signals Sig_V1 and Sig_V2, respectively, by the A/D converter 20. The digital speech waveform signals Sig_V1 and Sig_V2 are then input to the DSP 30. Based on the speech waveform signals Sig_V1 and Sig_V2, the DSP 30 generates a noise-less speech waveform signal and transmits the signal to the wireless communication apparatus 900. Moreover, the DSP 30 supplies a digital speech waveform signal received from the wireless communication apparatus 900 to the D/A converter 25. The digital speech waveform signal is converted into an analog speech waveform signal by the D/A converter 25 and then supplied to the speaker 106. In this embodiment, the DSP 30 processes the digital speech waveform signal Sig_V1 by VAD (Voice Activity Detection) to detect a speech segment for driving the LED 50, which will be described later in detail.

As shown in FIG. 3, the DSP 30 is provided with a speech-segment determination unit 31, a filter unit 32, an LED driver 33, and a subtracter 34. The digital speech waveform signal Sig_V1 output from the A/D converter 20 (FIG. 2) is supplied to the speech-segment determination unit 31 and the subtracter 34. The digital speech waveform signal Sig_V2 also output from the A/D converter 20 is supplied to the filter unit 32. The speech-segment determination unit 31 processes the digital speech waveform signal Sig_V1, which will be described later, and outputs a determination signal Sig_RD to the filter unit 32 and the LED driver 33. Based on the determination signal Sig_RD, the filter unit 32 processes the digital speech waveform signal Sig_V2, which will be described later, and outputs a waveform signal Sig_OL to the subtracter 34. The subtracter 34 subtracts the waveform signal Sig_OL from the digital speech waveform signal Sig_V1 to output a signal Sig_VO that is supplied to the wireless communication apparatus 900 shown in FIG. 1. The LED driver 33 outputs a signal Sig_LD (a drive current) to the LED 50 (FIG. 2) in response to the determination signal Sig_RD.

The configuration and operation of the DSP 30 shown in FIG. 3 will be described in detail.

The speech-segment determination unit 31 detects a speech segment or a non-speech segment based on the digital speech waveform signal Sig_V1 and outputs the determination signal Sig_RD that indicates the speech segment or non-speech segment.

Any appropriate technique can be used for the speech-segment determination unit 31 to detect a speech or non-input segment. For example, it is one feasible way for the speech-segment determination unit 31 to convert an input waveform signal by DCT (Discrete Cosine Transform) to detect the change in energy per unit of time in the frequency domain and determines that a speech segment is detected if the change in energy satisfies a specific requirement. Such a technique for the speech-segment determination unit 31 is disclosed, for example, in Japanese Unexamined Patent Publication Nos. 2004-272952 and 2009-294537, the entire content of which is incorporated herein by reference.

The filter unit 32 includes an LMS (Least Mean Square) adaptive filter, for example. The filter unit 32 performs a filtering process with adaptive filter convergence to estimate the transfer function of noises based on the digital speech waveform signal Sig_V2 and the output signal Sig_VO of the subtracter 34, thereby generating the waveform signal Sig_OL. In detail, the filter unit 32 estimates the transfer function of noises carried by the digital speech waveform signal Sig_V2 based on the difference in transfer function between the digital speech waveform signals Sig_V1 and Sig_V2 due to the difference in speech transfer path, reflection, etc., to generate the waveform signal Sig_OL. The difference in speech transfer path, reflection, etc., is caused by the difference in location of the voice pick-up microphone 105 and the noise pick-up microphone 108.

As described above, the speech-segment determination unit 31 supplies the determination signal Sig_RD to the filter unit 32. Based on the determination signal Sig_RD, the filter unit 32 detects a speech segment or non-speech segment and estimates the transfer function of noises appropriate for the detected segment. The determination signal Sig_RD may also be utilized in estimation of the transfer function of noises. For example, the determination signal Sig_RD may be utilized in learning at an LMS adaptive filter for each of speech and non-input segments, in adaptive filter convergence using the learning identification method. In this way, more accurate estimation is achieved for the transfer function of noises carried by the digital speech waveform signal Sig_V2. The filter unit 32 supplies the waveform signal Sig_OL generated based on the digital speech waveform signal Sig_V2 to the subtracter 34, that is subtracted from the digital speech waveform signal Sig_V1 for suppression of noises carried by the signal Sig_V1.

The filtering process to be performed by the filter unit 32 is not limited to the process described above. In the case of above, the filter unit 32 performs estimation of the transfer function of noises in accordance with the determination signal Sig_RD supplied from the speech-segment determination unit 31, to the speech waveform signal Sig_V2. However, the filtering process to be performed by the filter unit 32 may be changed in accordance with the level (a speech or non-speech segment) of the determination signal Sig_RD, suitable for the period in which a user is speaking or not. Moreover, the filter unit 32 may be put into an inoperative mode for power saving when the determination signal Sig_RD indicates the non-speech segment. Furthermore, the waveform signal Sig_OL to be used in suppression of noises carried by the signal Sig_V1 may be generated in various ways, in addition to the filtering process of the filter unit 32.

The LED driver 33 is a driver circuit for driving the LED 50. When the determination signal Sig_RD indicates a speech segment, the LED driver 33 supplies a drive current (the signal Sig_LD) to the LED 50 to turn on the LED 50. On the other hand, when the determination signal Sig_RD indicates a non-speech segment, the LED driver 33 supplies no drive current to the LED 50 to turn off the LED 50. The relation between the determination signal Sig_RD and the turn-on/off states of the LED 50 may be reversed.

The subtracter 34 is to subtract the output waveform signal Sig_OL of the filter unit 32 from the digital speech waveform signal Sig_V1 to suppress noises carried by the signal Sig_V1.

The operation of the speech input device 100 will be described with respect to FIGS. 4 and 5.

FIG. 4 shows an operation of the speech input device 100 that is placed at an appropriate location so that it can pick up a user's voice in a good voice pick-up state. In this good state: the voice pick-up microphone 105 is located to face the user's mouth close enough to pick up the user's voice at a high level; on the other hand, the noise pick-up microphone 108 is located opposite of the microphone 105 so that it picks up the user's voice at a very low level; and the source of noise is far from the speech input device 100 so that the microphones 105 and 108 pick up noises almost at the same level. FIG. 5 shows an operation of the speech input device 100 that is placed at an inappropriate location so that it cannot pick up a user's voice in a good voice pick-up state. In FIGS. 4 and 5, the signs On and OFF indicate that the LED 109 (50) is turned on and off, respectively.

In FIG. 4, the speech waveform signal Sig_V1 (FIG. 2) obtained from the sound picked up by the voice pick-up microphone 105 has periods of large magnitude and periods of small magnitude, clearly distinguishable between voices and noises. The speech-segment determination unit 31 processes the speech waveform signal Sig_V1 as described above to detect speech segments and non-speech segments to output a determination signal Sig_RD based on the detection. The determination signal Sig_RD is, for example, a binary signal having a high level and a low level indicating a speech segment and a non-speech segment, respectively. On receiving a high-level determination signal Sig_RD, the LED driver 33 supplies a drive current (the signal Sig_LD) to turn on the LED 50. On receiving a low-level determination signal Sig_RD, the LED driver 33 supplies no drive current to turn off the LED 50. In FIG. 4, the LED 50 is turned on during periods (t1-t2), (t3-t4), (t5-t6) and (t7-t8) whereas turned off during periods (t2-t3), (t4-t5) and (t6-t7), and so on with the repetition of turn-on/off at a slow cycle.

In FIG. 5, the speech waveform signal Sig_V1 (FIG. 2) obtained from the sound picked up by the voice pick-up microphone 105 has periods of large and small magnitude but unclear therebetween, and thus undistinguishable between voices and noises. The waveform indicates that voices are embedded in noises. In the same way as explained with respect to FIG. 4, on receiving a high-level determination signal Sig_RD from the speech-segment determination unit 31, the LED driver 33 supplies a drive current (the signal Sig_LD) to turn on the LED 50. On receiving a low-level signal Sig_RD, the LED driver 33 supplies no drive current to turn off the LED 50. In FIG. 5, the LED 50 is turned on during periods (t1-t2), (t3-t4), (t5-t6), (t7-t8), (t9-t10), (t11-t12) and (t13-t14) whereas turned off during periods (t2-t3), (t4-t5), (t6-t7), (t8-t9), (t10-t11) and (t12-t13), and so on with the repetition of turn-on/off at a fast cycle.

FIGS. 4 and 5 teach that the turn-on/off of the LED 50 depends on whether the speech input device 100 picks up a user's voice at an appropriate voice pick-up state or not. In other words, a user can know whether the turn-on/off of the LED 50 is synchronized with the user's speaking by watching the LED 50 while the user is talking into the speech input device 100. This means that the speech input device 100 can inform a user of the voice pick-up state, by synchronizing the turn-on of the LED 50 with the speech segments. It is also possible to synchronize the turn-on of the LED 50 with the non-speech segments to inform a user of the voice pick-up state, although not visually intuitive.

As described above, the speech input device 100 in this embodiment detects speech segments and turns on the LED 50 in synchronism with the speech segments, to inform a user of the voice pick-up state at the device 100.

For ordinary mobile phones, it is hard to assume the difficulty in picking up a user's voice due to the inappropriate location of a microphone. This is because a microphone is attached to a mobile phone at a fixed location. However, such assumption is inherent in a wireless communication apparatus for professional use and related to the present invention. This is because a speech input device is connected to a main body of the communication apparatus through a cord so that the location of the speech input device is changeable. Therefore, it is difficult for users of such wireless communication apparatus to hold a speech input device any time at a substantially same location so that the speech input device can pick up a user's voice at a good voice pick up state, even if enough guidance is provided.

The present invention was conceived in order to solve such a problem of wireless communication apparatus for professional use. In the embodiment, as described above, the speech-segment determination unit 31 determines speech segments and non-speech segments corresponding to the periods during which a user is speaking and not speaking, respectively. Then, the speech-segment determination unit 31 turns on/off the LED 50 via the LED driver 33 in synchronism with the speech and non-speech segments, respectively. The turn-on/off state of the LED 50 indicates a user of whether the current location of the speech input device 100 is appropriate to be in a good voice pick-up state. Depending on the turn-on/off state of the LED 50, the user can place the voice pick-up microphone 105 and the noise pick-up microphone 108 at an appropriate location to make the speech input device 100 in a good voice pick-up state. The relocation of the microphones 105 and 108 to find a good voice pick-up state leads to suppression of a noise component carried by the digital speech waveform signal Sig_V1 obtained from the sound picked up by the microphone 105. The noise suppression results in higher quality of a speech waveform signal transmitted from the wireless communication apparatus 900.

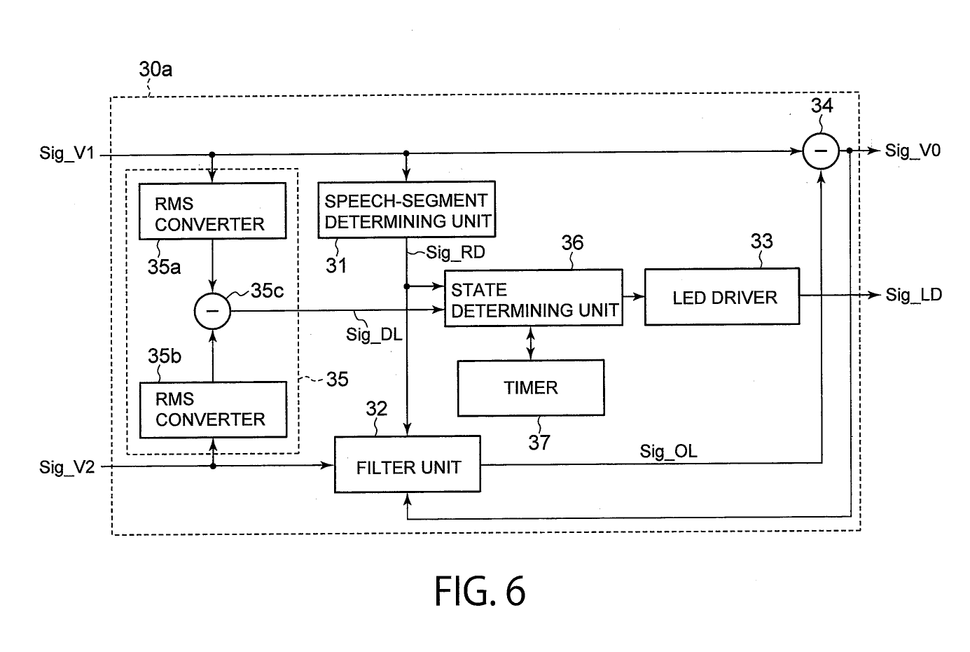

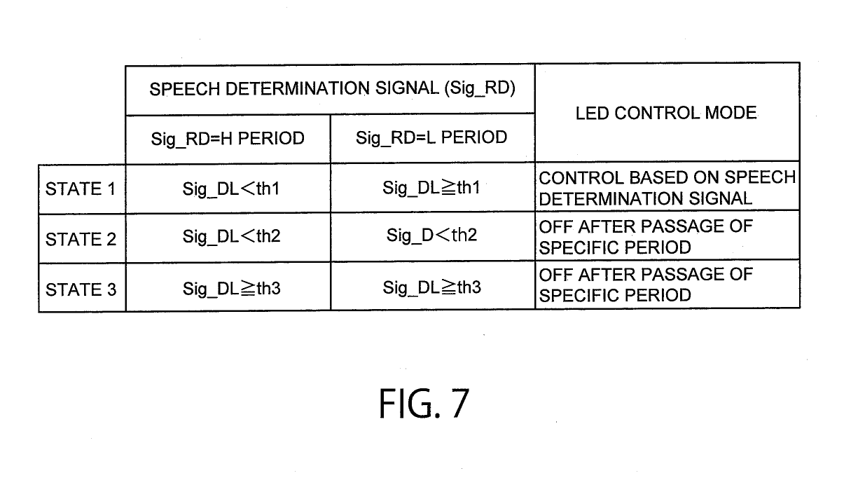

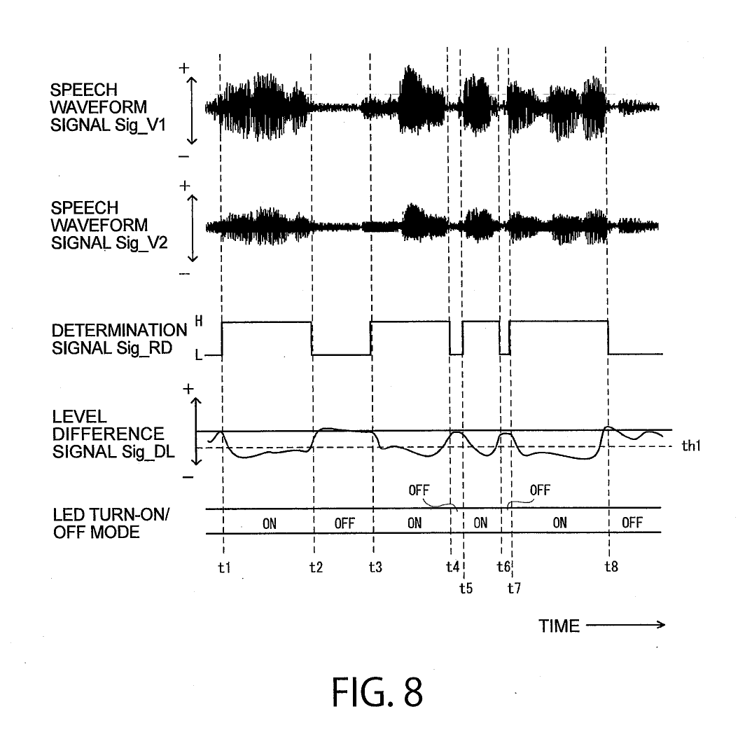

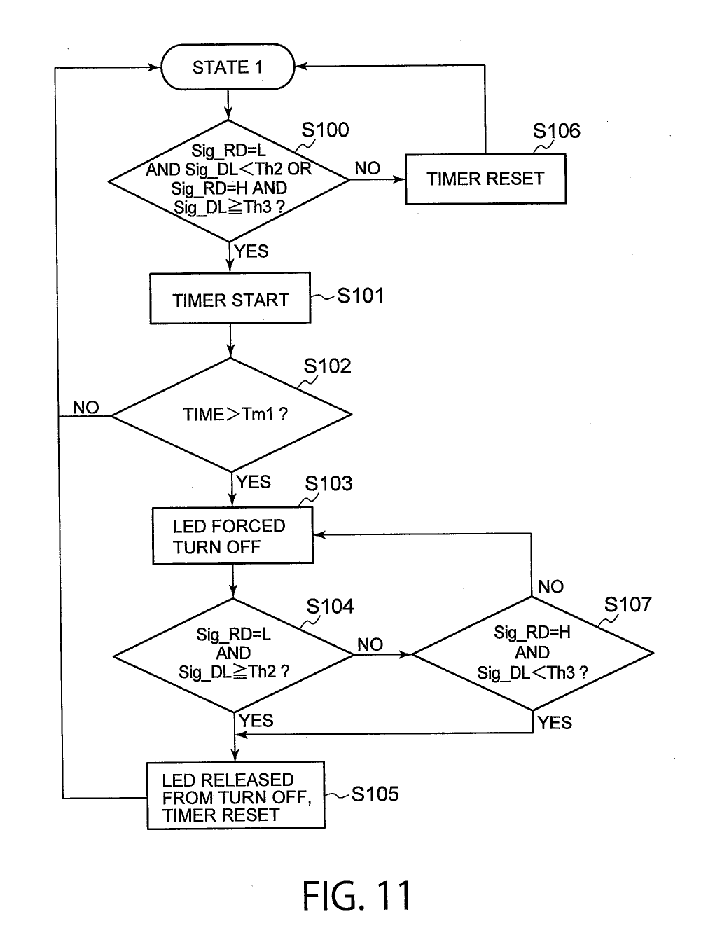

Described next with respect to FIGS. 6 to 11 is a first modification to the DSP 30 shown in FIG. 3. FIG. 6 is a schematic block diagram of a DSP 30a that is the first modification to the DSP 30. FIG. 7 is a view showing an operation of the DSP 30a shown in FIG. 6. FIGS. 8 to 10 are schematic timing charts each showing an operation of the DSP 30a, with an illustration of speech waveform signals. FIG. 11 is a schematic flow chart showing an operation of the DSP 30a.

The DSP 30a shown in FIG. 6 is provided with (as main elements): a level difference detector 35 that generates a signal depending on the level of signal strength of a speech waveform signal supplied from the noise pick-up microphone 11 (more in detail, a signal depending on the difference in level of signal strength of speech waveform signals supplied from the voice pick-up microphone 10 and the noise pick-up microphone 11); and a state determining unit 36 that determines whether to continue the operation of informing a user of a speech-segment detecting state at the speech-segment determination unit 31 based on the determination signal Sig_RD from the determination unit 31 and the output signal of the level difference detector 35.

With the level difference detector 35 and the state determining unit 36, it is possible to inform a user of a voice pick-up state at the speech input device 100 depending on the location of both of the voice pick-up microphone 105 and the noise pick-up microphone 108. For example, it can be detected that the noise pick-up microphone 108 is in a bad voice pick-up state, a user's voice is picked up by the microphones 105 and 108 almost simultaneously, etc. and the detected state can be informed to the user.

As shown in FIG. 6, the DSP 30a is provided with the level difference detector 35, the state determining unit 36, and a timer 37, in addition to the speech-segment determination unit 31, the filter unit 32, the LED driver 33, and the subtracter 34, shown in FIG. 3. The level difference detector 35 is provided with RMS (Root Mean Square) converters 35a and 35b, and a subtracter 35c. The level difference detector 35 is a signal generator for generating a signal depending on the level of signal strength of the speech waveform signal Sig_V2 supplied from the A/D converter 20 (FIG. 2) based on the sound picked up by the noise pick-up microphone 11.

The informing (indicating) unit of the speech input device 100 having the DSP 30a includes the state determining unit 36, the timer 37, the LED driver 33, and the LED 50, although not limited thereto.

The operation of the DSP 30a will be described in detail.

The speech waveform signals Sig_V1 and Sig_V2 output from the A/D converter 20 (FIG. 2) based on the sounds picked up by the voice pick-up microphone 10 and the noise pick-up microphone 11 are supplied to the RMS converters 35a and 35b, respectively. The outputs of the RMS converters 35a and 35b are supplied to the subtracter 35c. The output of the subtracter 35c is supplied to the state determining unit 36. Also supplied to the state determining unit 36 is the output of the speech-segment determination unit 31. Based on the output of the subtracter 35c, the speech-segment determination unit 31 makes the timer 31 start time measurement.

The RMS converters 35a and 35b convert the speech waveform signals Sig_V1 and Sig_V2 by RMS conversion to obtain a level of signal strength of the signals Sig_V1 and Sig_V2, respectively. The RMS conversion is referred to as calculation called root mean square that is the square root of the mean level of the squared level of a given level. With the RMS conversion, a level of signal strength of a varying signal can be obtained.

The subtracter 35c subtracts the output level of the RMS converter 35a from the output level of the RMS converter 35b to generate a level difference signal Sig_DL in accordance with the level difference between the speech waveform signals Sig_V1 and Sig_V2.

The state determining unit 36 controls the LED driver 33 based on the determination signal Sig_RD supplied from the speech-segment determination unit 31 and the level difference signal Sig_DL supplied from the subtracter 35c of the level difference detector 35. The state determining unit 36 refers to the determination signal Sig_RD and then compares the level difference signal Sig_DL with specific threshold levels, to detect any of a state 1, a state 2, and a state 3 shown in FIG. 7.

The operation of the state determining unit 36 will be described with reference to FIGS. 7 to 10. The states 1, 2 and 3 listed in the table of FIG. 7 correspond to the states shown in FIGS. 8, 9 and 10, respectively.

FIG. 8 shows a similar state to that shown in FIG. 4 in which the speech input device 100 is placed at an appropriate location so that it can pick up a user's voice in a good voice pick-up state.

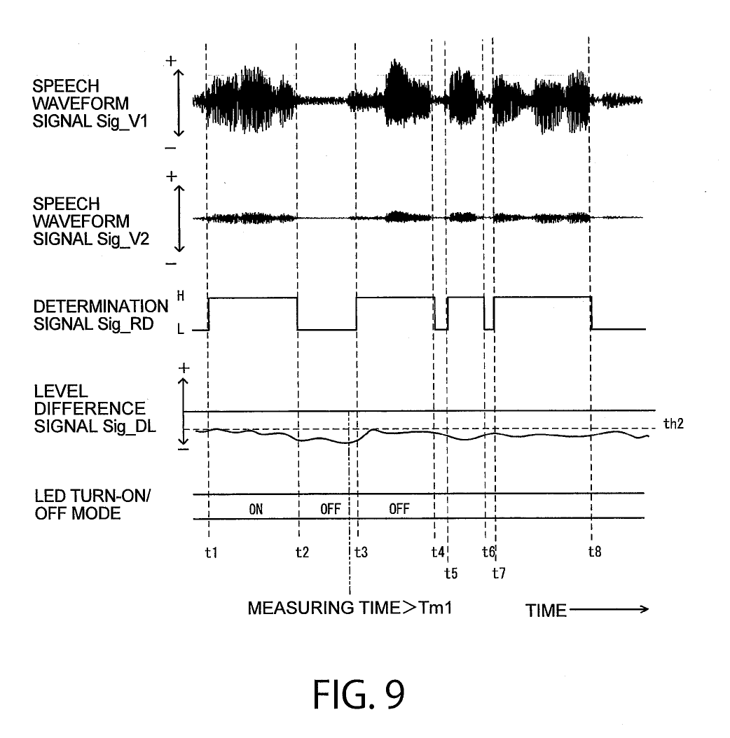

FIG. 9 shows a particular state in which the voice pick-up microphone 105 picks up voices at an appropriate level whereas the noise pick-up microphone 108 picks up almost no voices and noises. This kind of state tends to occur when a user speaks into the speech input device 100 while the user attaches the device 100 to the user's clothes so that the microphone 108 is covered by the clothes, for example.

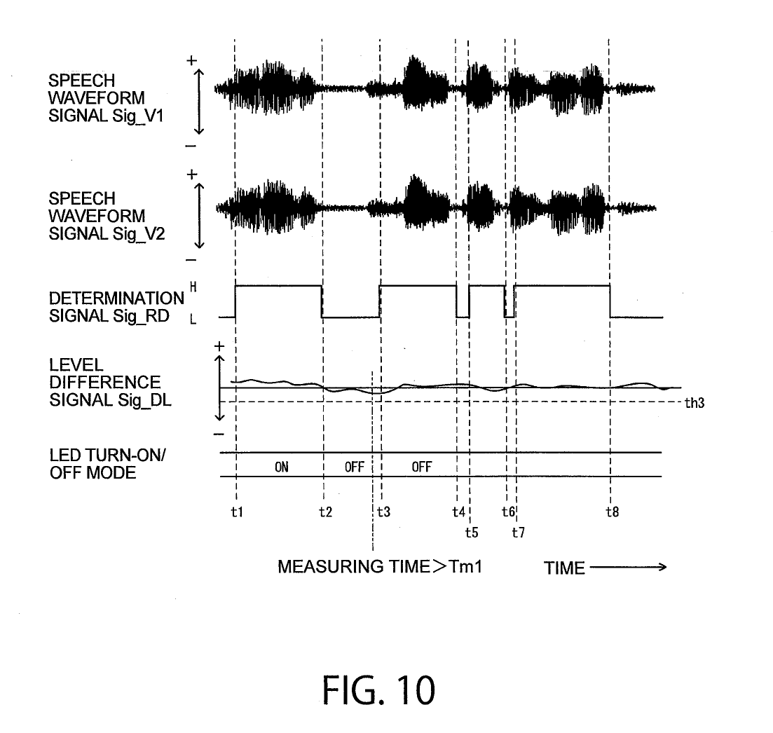

FIG. 10 shows a particular state in which the voice pick-up microphone 105 and the noise pick-up microphone 108 pick up voices and noises almost at the same level. This kind of state tends to occur when a user speaks into the speech input device 100, for example, while the user attaches the device 100 to the user's clothes, for instance, around the abdomen. That is, the user does not speak into the voice pick-up microphone 105 (10) located in front of the user because the user does not hold the speech input device 100 appropriately, for example.

In the state 1, as shown in FIG. 7, the level difference signal Sig_DL is at a level lower than a threshold level th1 (Sig_DL<th1) while the determination signal Sig_RD is at a high level whereas equal to or higher than the level th1 (Sig_DL≧th1) while the signal Sig_RD is at a low level. On receiving the level difference signal Sig_DL from the level difference detector 35, the state determining unit 36 detects the state 1 in which the speech input device 100 is in a good sound pick-up state, as shown in FIG. 8. Then, the state determining unit 36 determines that the speech input device 100 is in a good sound pick-up state at present. After this determination, the state determining unit 36 passes the determination signal Sig_RD output from the speech-segment determination unit 31 to the LED driver 33. When the LED driver 33 receives a high-level signal Sig_RD, it supplies a drive current (Sig_LD) to turn on the LED 50. On the other hand, when the LED driver 33 receives a low-level signal Sig_RD, it supplies no drive current to turn off the LED 50. The LED 50 repeats turn-on and turn-off at a slow cycle in the same way as described with reference to FIG. 4.

In the state 2, as shown in FIG. 7, the level difference signal Sig_DL is at a level lower than a threshold level th2 (Sig_DL<th2) while the determination signal Sig_RD is at a high level and also at a low level. On receiving the level difference signal Sig_DL from the level difference detector 35, the state determining unit 36 detects the stats 2 in which the speech input device 100 is in a bad sound pick-up state. In the state 2, the state determining unit 36 determines that the noise pick-up microphone 108 is in a bad sound pick-up state, as shown in FIG. 9. When the state 2 continues for a specific period of time measured by the timer 37 as described later, the state determining unit 36 sets a signal (Sig_LD) to be supplied to the LED driver 33 to a low level constantly. In response to a constant low-level signal, the LED driver 33 drives the LED 50 into a continuous turn-off state to inform a user of an abnormal sound pick-up state at the speech input device 100. In FIG. 9, the LED 50 is forcibly and continuously turned off after the period (t1-t2).

In the state 3, as shown in FIG. 7, the level difference signal Sig_DL is at a level equal to or higher than a threshold level th3 (Sig_DL≧th3) while the determination signal Sig_RD is at a high level and also at a low level. On receiving the level difference signal Sig_DL from the level difference detector 35, the state determining unit 36 detects the state 3 in which the speech input device 100 is in a bad sound pick-up state. In the state 3, the state determining unit 36 determines that both of the voice pick-up microphone 105 and the noise pick-up microphone 108 are in a bad sound pick-up state, as shown in FIG. 10. In this determination, the state determining unit 36 detects that a user's voice reaches both of the voice pick-up microphone 105 and the noise pick-up microphone 108. When the state 3 continues for a specific period of time measured by the timer 37 as described later, the state determining unit 36 sets a signal (Sig_LD) to be supplied to the LED driver 33 to a low level constantly. In response to a constant low-level signal, the LED driver 33 drives the LED 50 into a continuous turn-off state to inform a user of an abnormal sound pick-up state at the speech input device 100. In FIG. 10, the LED 50 is forcibly and continuously turned off after the period (t1-t2).

The operation of the speech input device 100 equipped with the DSP 30a (FIG. 6) is described further with respect to a flow chart of FIG. 11.

The flow chart starts with the supposition that the speech input device 100 is in the state 1 in which the speech input device 100 is operating in a good sound pick-up state at present. Moreover, in the exemplary operation of the speech input device 100 shown in FIG. 11, all the threshold levels th1, th2 and th3 (FIG.

7) are set to the same level. However, the threshold levels may be set to levels to have the relationship th1_{>}th2>th3. This threshold-level setting makes the speech input device 100 high sensitive to a bad sound pick-up state at the noise pick-up microphone 108, for example, when the microphone 108 is covered with user's clothes, to quickly turn off the LED 109. In addition, the threshold-level setting makes the speech input device 100 higher sensitive to a bad sound pick-up state at the noise pick-up microphone 108, for example, when the user's mouth faces the side face of the device 100 with the microphones 105 and 108 on the front and rear faces thereof, respectively, to more quickly turn off the LED 109. It is preferable to make the threshold-level setting empirically depending on the surrounding conditions, environments, etc.

In FIG. 11, the state determining unit 36 compares in step S100 the level of the level difference signal Sig_DL from the level difference detector 35 with the threshold levels th2 and th3 while receiving the determination signal Sig_RD from the speech-segment determination unit 31. Then, the state determining unit 36 determines: whether the signal Sig_DL is at a level lower than the level th2 (state 2) while receiving a low-level determination signal Sig_RD; or whether the signal Sig_DL is at a level equal to or higher than the level th3 (state 3) while receiving a high-level determination signal Sig_RD.

If Yes in step S100 in which a requirement ((Sig_RD=L and Sig_DL<th2) or (Sig_RD=H and Sig_DL≧th3)) is satisfied, the state determining unit 36 makes the timer 37 start time measurement in step S101. Then, the state determining unit 36 determines in step S102 whether the time measured by the timer 37 has passed a specific time Tm1.

If No in step S102 (time≦Tm1), the state determining unit 36 repeats steps S100 to S102 until the measured time has passed the time Tm1. Step S101 is skipped when the timer 37 has started time measurement. If No in step S100 ((Sig_RD=L and Sig_DL≧th2) or (Sig_RD=H and Sig_DL<th3)), the state determining unit 36 initializes the timer 37 in step S106 and the speech input device 100 continues to be in the state 1.

If Yes in step S102 that the measured time has passed the specific time Tm1 (time>Tm1), the state determining unit 36 detects this state (time>Tm1 for which the state 2 or 3 had continued) and forcibly turns off the LED 50 in step S103.

Thereafter, the state determining unit 36 determines in step S104 whether the determination signal Sig_RD is at a low level (Sig_RD=L) and the difference signal Sig_DL is at a level equal to or higher than the threshold level th2 (Sig_DL≧th2), different from the state 2 in FIG. 7.

If Yes in step S104 (Sig_RD=L and Sig_DL≧th2), the state determining unit 36 turns on the LED 50 via the LED driver 33 and initializes the timer 37 in step S105. Then, the speech input device 100 returns to the state 1.

On the other hand, if No in step S104, the state determining unit 36 determines in step S107 whether the determination signal Sig_RD is at a high level (Sig_RD=H) and the difference signal Sig_DL is at a level lower than the threshold level th3 (Sig_DL<th3), different from the state 3 in FIG. 7.

If Yes in step S107 (Sig_RD=H and Sig_DL<th3), the state determining unit 36 turns on the LED 50 via the LED driver 33 and initializes the timer 37 in step S105. Then, the speech input device 100 returns to the state 1. If No in step S107, the state determining unit 36 continues forced turn-off of the LED 50 in step S103.

In the flow chart of FIG. 11, steps S100, S101, S102 and S S106 require detection of the level of the determination signal Sig_RD for detection of the state 2 or 3, as described above. However, it is also preferable to detect the state 2 or 3 if a state of Sig_DL<th2 or Sig_DL≧th3 continues for a period that is deemed to be too long for the determination signal Sig_RD to maintain a high or low level, a period that is deemed to be too long for the determination signal Sig_RD to maintain a high or low level, thus turning off the LED 50, with no requirement of detection of the level of the signal Sig_RD.

In detail, as shown in FIG. 7, in the state 1, the level of the level difference Sig_DL becomes higher (or equal to) or lower than the threshold level th1 depending on a high or low level of the determination signal Sig_RD. On the other hand, in the state 2, the level of the level difference Sig_DL is always lower than the threshold level th2 irrespective of the level of the determination signal Sig_RD.

Therefore, it is also preferable to detect a period of the state of Sig_DL<th2 by the timer 37 and if the period measured by the timer 37 has passed a specific period Tm3, it is deemed that the current state is the state 2 in which the level difference Sig_DL does not follow the change in level of the determination signal Sig_RD (like the state 1), thus turning off the LED 50. The specific period Tm3 is set, for example, to five seconds, that is a period deemed to be too long for the determination signal Sig_RD to maintain a high level for which a speech segment continues.

Moreover, as shown in FIG. 7, in the state 3, the level of the level difference Sig_DL is always equal to or higher than the threshold level th3 irrespective of the level of the determination signal Sig_RD.

Therefore, it is also preferable to detect a period of the state of Sig_DL≧th3 by the timer 37 and if the period measured by the timer 37 has passed a specific period Tm4, it is deemed that the current state is the state 3 in which the level difference Sig_DL does not follow the change in level of the determination signal Sig_RD (like the state 1), thus turning off the LED 50. The specific period Tm4 is set, for example, to five seconds, that is a period deemed to be too long for the determination signal Sig_RD to maintain a low level for which a speech segment continues.

As described above in detail, equipped with the DSP 30a (FIG. 6), the speech input device 100 informs a user of the current sound pick-up state by detecting the pick-up states at both of the voice pick-up microphone 105 and the noise pick-up microphone 108.

In detail, as shown in (a) and (b) of FIG. 1, the voice pick-up microphone 105 and the noise pick-up microphone 108 are attached to the speech input device 100 on both sides of the main body 101. The is the typical arrangements of the voice and noise pick-up microphones for a wireless communication apparatus for professional use related to the present invention. Suppose that a user attaches the speech input device 100 to the user's chest or shoulder with the voice pick-up microphone 105 at the front side and the noise pick-up microphone 108 at the rear side so that microphone 108 touches or is covered by the user's clothes. In this case, it could happen that sounds do not reach the noise pick-up microphone 108 appropriately. In order to avoid such a problem, as described with reference to FIG. 9, an inappropriate sound pick-up state at the noise pick-up microphone 108 is detected and informed to the user, in the first modification. Then, the user can change the location of the speech input apparatus 100 so that the noise pick-up microphone 108 can pick up sounds appropriately. When the microphone 108 picks up sounds appropriately, the speech input device 100 can suppress a noise component carried by the digital speech waveform signal Sig_V1 produced from the users' voice picked up by the voice pick-up microphone 105. This results in higher quality of a speech waveform signal transmitted from the wireless communication apparatus 900.

Moreover, as shown in (a) and (b) of FIG. 1, the voice pick-up microphone 105 and the noise pick-up microphone 108 are located close on both sides of the main body 101 of the speech input device 100. It could thus happen that a user's voice reaches the microphones 105 and 108 almost simultaneously, for example, when the user's mouth faces the side face of the main body 101 with the microphones 105 and 108 on the front and rear faces thereof, respectively. In this case, as described with reference to FIG. 10, it is detected that the user's voice is input to both of the microphones 105 and 108, and this state is informed to the user. Then, the user can change the location of the speech input device 100 so that the noise pick-up microphone 108 can pick up sounds appropriately. When the microphone 108 picks up sounds appropriately, the speech input device 100 can suppress a noise component carried by the digital speech waveform signal Sig_V1 produced from the users' voice picked up by the voice pick-up microphone 105. This results in higher quality of a speech waveform signal transmitted from the wireless communication apparatus 900.

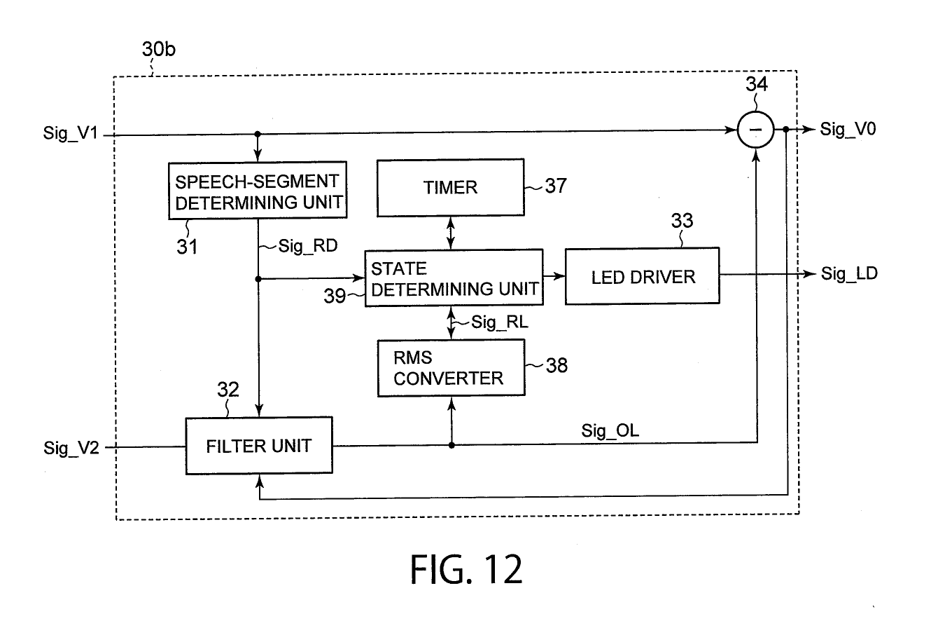

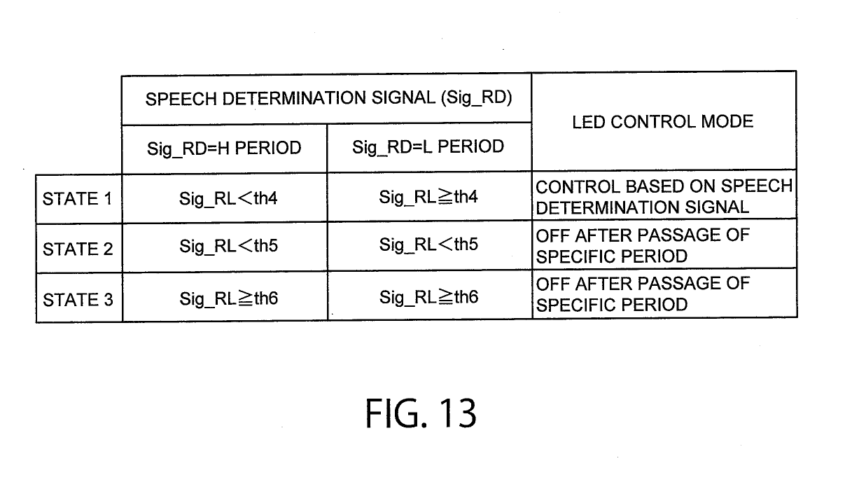

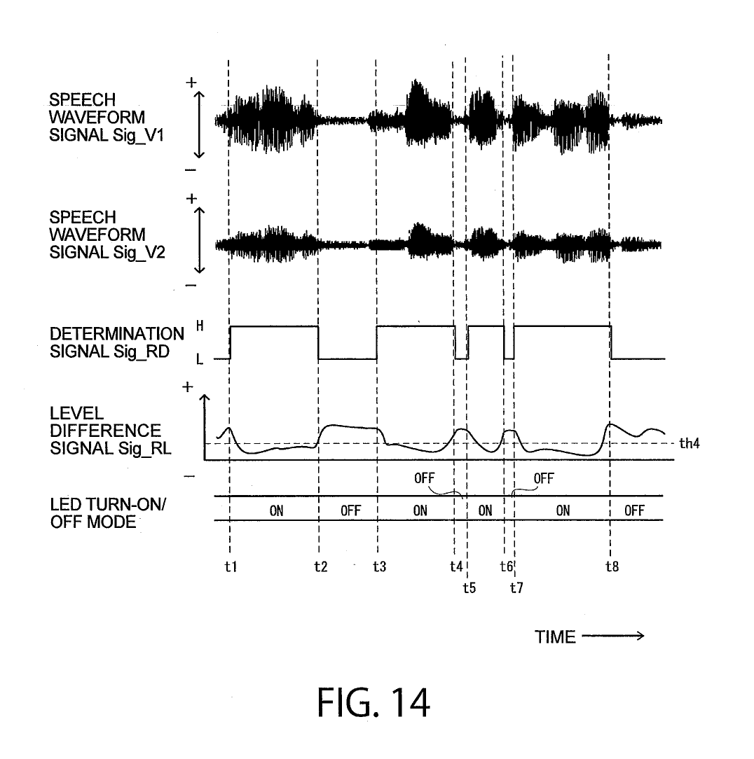

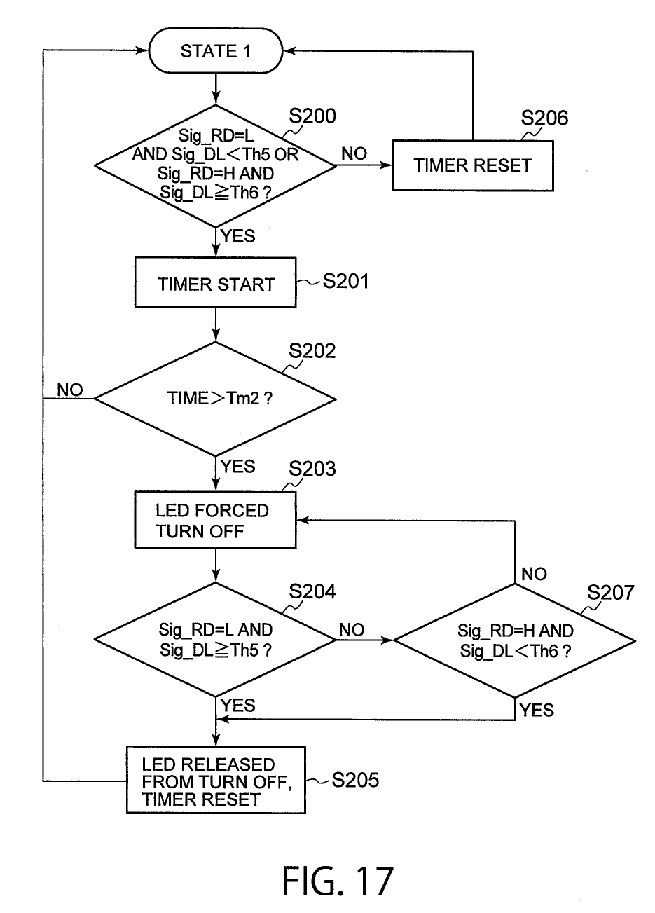

Described next with respect to FIGS. 12 to 17 is a second modification to the DSP 30 shown in FIG. 3. FIG. 12 is a schematic block diagram of a DSP 30b that is the second modification to the DSP 30. FIG. 13 is a view showing an operation of the DSP 30b shown in FIG. 12. FIGS. 14 to 16 are schematic timing charts each showing an operation of the DSP 30b, with an illustration of speech waveform signals. FIG. 17 is a schematic flow chart showing an operation of the DSP 30b.

The DSP 30b shown in FIG. 12 is provided with (as main elements): an RMS converter 38 (identical to the RMS converters 35a and 35b shown in FIG. 6) that generates a signal depending on the level of signal strength of a speech waveform signal supplied from the noise pick-up microphone 11 (FIG. 2); and a state determining unit 39 that determines whether to continue the operation of informing a user of the speech-segment detecting state at the speech-segment determination unit 31 based on the determination signal Sig_RD output from the determination unit 31 and the output signal of the RMS converter 38.

Different from the first modification, in the second modification, a sound pick-up state is determined based on the level of signal strength of the output signal of the RMS converter 38 and then the turn-on/off state of the LED 50 is controlled in accordance with the determined sound pick-up state. These are the differences of the second modification from the first modification. However, also in the second modification, a sound pick-up state at the speech input device 100 can be determined by detecting the voice and noise pick-up states at the microphones 105 and 108, respectively, and the sound pick-up state is informed to the user. Then, the user can change the location of the speech input device 100 so that the noise pick-up microphone 108 can pick up sounds appropriately. When the microphone 108 can pick up sounds appropriately, the speech input device 100 can suppress a noise component carried by the digital speech waveform signal Sig_V1 produced from the user's voice picked up by the voice pick-up microphone 105. This results in higher quality of a speech waveform signal transmitted from the wireless communication apparatus 900. Moreover, the second modification is provided with the RMS converter 38 instead of the level difference detector 35 shown in FIG. 6 (the first modification). Since the RMS converter 38 is identical to the RMS converters 35a and 35b of the level difference detector 35, the second modification is achieved with simpler circuitry than the first modification.

As shown in FIG. 12, the DSP 30b is provided with the RMS converter 38 and the state determining unit 39, in addition to the speech-segment determination unit 31, the filter unit 32, the LED driver 33, the subtracter 34, and the timer 37, shown in FIG. 6. The RMS converter 38 receives an output signal of the filter unit 32 and the supplies an output signal to the state determining unit 39. The RMS converter 38 is a signal generator for generating a signal depending on the level of signal strength of the speech waveform signal Sig_V2 supplied from the A/D converter 20 shown in FIG. 2. The informing (indicating) unit in the second modification includes the state determining unit 39, the timer 37, the LED driver 33, and the LED 50, although not limited thereto.

The operation of the DSP 30b will be described in detail.

The speech waveform signal Sig_V2 output from the A/D converter 20 (FIG. 2) based on the sounds picked up by the noise pick-up microphone 11 is supplied to the filter unit 32 that then supplies a waveform signal Sig_OL to the RMS converter 38. The RMS converter 38 converts the waveform signal Sig_OL by RMS conversion to obtain the level of signal strength of the Sig_OL and generates a level signal Sig_RL.

The state determining unit 39 controls the LED driver 33 based on the determination signal Sig_RD supplied from the speech-segment determination unit 31 and the level signal Sig_RL supplied from the RMS converter 38. The state determining unit 39 compares the level signal Sig_RL with specific threshold levels based on the determination signal Sig_RD, to detect any of a state 1, a state 2, and a state 3 shown in FIG. 13.

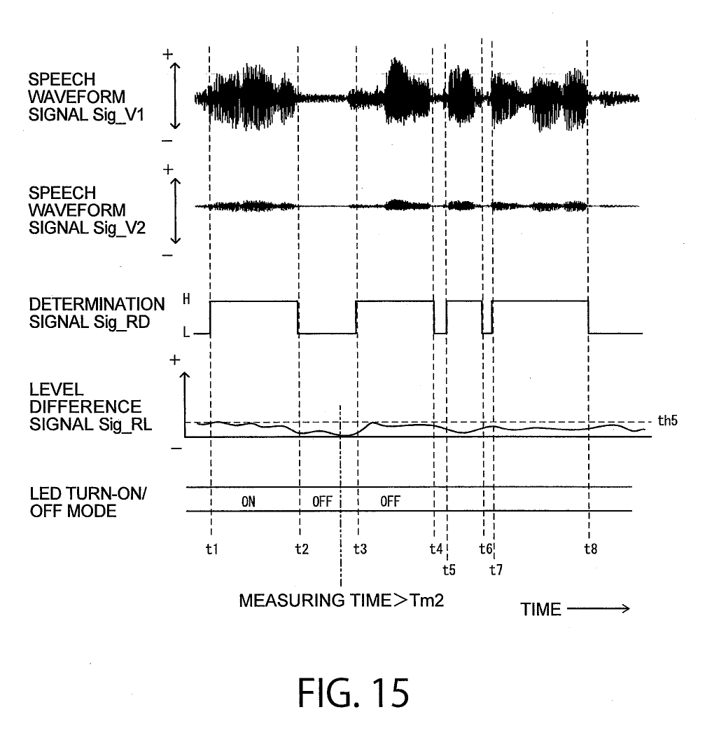

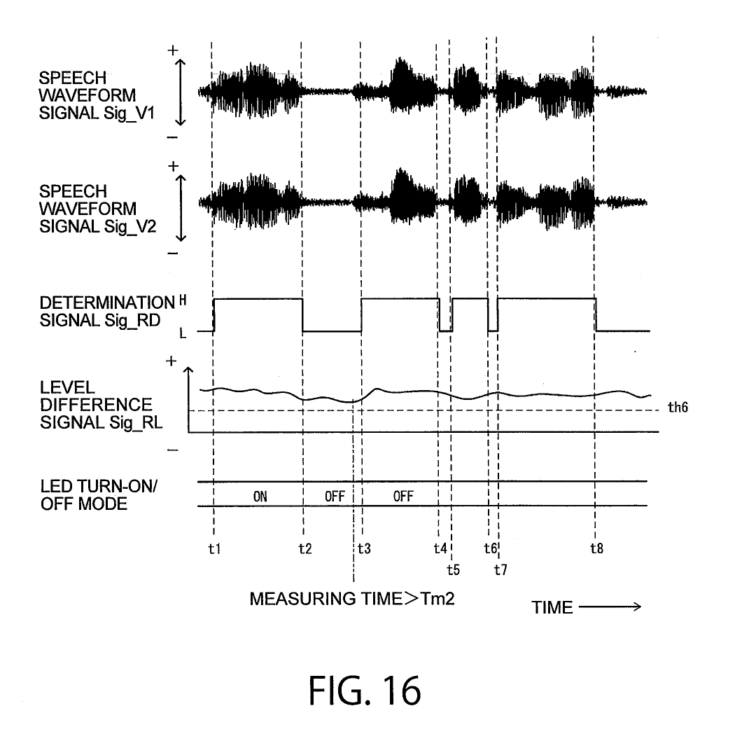

The operation of the state determining unit 39 will be described with reference to FIGS. 13 to 16. The states 1, 2 and 3 listed in the table of FIG. 13 correspond to the states shown in FIGS. 14, 15 and 16, respectively. FIG. 14 shows a similar state to those shown in FIGS. 4 and 8. FIG. 15 shows a similar state to that shown in FIG. 9. FIG. 16 shows a similar state to that shown in FIG. 10.

In the state 1, shown in FIG. 13, the level signal Sig_RL is at a level lower than a threshold level th4 (Sig_RL_{<}th4) while the determination signal Sig_RD is at a high level whereas equal to or higher than the level th4 (Sig_RL≧th4) while the signal Sig_RD is at a low level. On receiving the level Sig_RL from the RMS converter 38, the state determining unit 39 detects the state 1 in which the speech input device 100 is in a good sound pick-up state, as shown in FIG. 14. Then, the state determining unit 39 determines that the speech input device 100 is in a good sound pick-up state at present. After this determination, the state determining unit 39 passes the determination signal Sig_RD output from the speech-segment determination unit 31 to the LED driver 33. When the LED driver 33 receives a high-level signal Sig_RD, it supplies a drive current to turn on the LED 50. On the other hand, when the LED driver 33 receives a low-level signal Sig_RD, it supplies no drive current to turn off the LED 50. The LED 50 repeats turn-on and turn-off at a slow cycle, in the same way as described with reference to FIG. 4.

In the state 2, shown in FIG. 13, the level signal Sig_RL is at a level lower than a threshold level th5 (Sig_RL<th5) while the determination signal Sig_RD is at a high level and also at a low level. On receiving the level signal Sig_RL from the level RMS converter 38, the state determining unit 39 detects the state 2 in which the speech input device 100 is in a bad sound pick-up state. In the state 2, the state determining unit 39 determines that the noise pick-up microphone 108 is in a bad sound pick-up state, as shown in FIG. 15. When the state 2 continues for a specific period of time measured by the timer 37 as described later, the state determining unit 39 sets a signal to be supplied to the LED driver 33 to a low level constantly. In response to a constant low-level signal, the LED driver 33 drives the LED 50 into a continuous turn-off state to inform a user of an abnormal sound pick-up state at the speech input device 100. In FIG. 15, the LED 50 is forcibly and continuously turned off after the period (t1-t2).

In the state 3, shown in FIG. 13, the level signal Sig_RL is at a level equal to or higher than a threshold level th6 (Sig_RL≧th6) while the determination signal Sig_RD is at a high level and also at a low level. On receiving the level signal Sig_RL from the RMA converter 38, the state determining unit 39 detects the state 3 in which the speech input device 100 is in a bad sound pick-up state. In the state 3, the state determining unit 36 determines that both of the voice pick-up microphone 105 and the noise pick-up microphone 108 are in a bad sound pick-up state, as shown in FIG. 15. In this determination, the state determining unit 36 detects that a user's voice reaches both of the voice pick-up microphone 105 and the noise pick-up microphone 108. When the state 3 continues for a specific period of time measured by the timer 37 as described later, the state determining unit 39 sets a signal to be supplied to the LED driver 33 to a low level constantly. In response to a constant low-level signal, the LED driver 33 drives the LED 50 into a continuous turn-off state to inform a user of an abnormal sound pick-up state at the speech input device 100. In FIG. 15, the LED 50 is forcibly and continuously turned off after the period (t1-t2).

The operation of the speech input device 100 equipped with the DSP 30b (FIG. 12) is described further with respect to a flow chart of FIG. 17. The flow chart starts with the supposition that the speech input device 100 is in the state 1 in which the speech input device 100 is operating at present in a good sound pick-up state. Moreover, in the exemplary operation of the speech input device 100 shown in FIG. 14, all the threshold levels th4, th5 and th6 (FIG. 13) are set to the same level. However, the threshold levels may be set to levels to have the relationship th4>th5>th6. This threshold-level setting makes the speech input device 100 high sensitive to a bad sound pick-up state at the noise pick-up microphone 108, for example, when the microphone 108 is covered with user's clothes, to quickly turn off the LED 109. In addition, the threshold-level setting makes the speech input device 100 higher sensitive to a bad sound pick-up state at the noise pick-up microphone 108 (11), for example, when the user's mouth faces the side face of the device 100 with the microphones 105 (10) and 108 (11) on the front and rear faces thereof, respectively, to more quickly turn off the LED 109 (50). It is preferable to make the threshold-level setting empirically depending on the surrounding conditions, environments, etc.

In FIG. 17, the state determining unit 39 compares in step S200 the level of the level signal Sig_RL and the threshold levels th5 and th6 to determine whether the signal Sig_RL is at a level lower than the level th5 (state 2) while receiving a low-level determination signal Sig_RD; or whether the signal Sig_DL is at a level equal to or higher than the level th6 (state 3) while receiving a high-level determination signal Sig_RD.

If Yes in step S200 in which a requirement ((Sig_RD=L and Sig_DL<th5) or Sig_RD=H and Sig_DL≧th6)) is satisfied, the state determining unit 39 makes the timer 37 start time measurement in step S201. Then, the state determining unit 39 determines in step S202 whether the time measured by the timer 37 has passed a specific time Tm2.

If No in step S202 (time≦Tm2), the state determining unit 39 repeats steps S200 to S202 until the measured time has passed the time Tm2. Step S201 is skipped when the timer 37 has started time measurement. If No in step S200 ((Sig_RD=L and Sig_DL≧th5) or Sig_RD=H and Sig_DL<th6)), the state determining unit 39 initializes the timer 37 in step S206 and the speech input device 100 continues to be in the state 1.

If Yes in step S202 that the measured time has passed the specific time Tm2 (time>Tm2), the state determining unit 39 detects this state (time>Tm2 for which the state 2 or 3 has continued) and forcibly turns off the LED 50 in step S203.

Thereafter, the state determining unit 39 determines in step S204 whether the determination signal Sig_RD is at a low level (Sig_RD=L) and the difference signal Sig_DL is at a level equal to or higher than the threshold level th5 (Sig_DL≧th5), different from the state 2 in FIG. 13.

If Yes in step S204 (Sig_RD=L and Sig_DL≧th5), the state determining unit 39 turns on the LED 50 and initializes the timer 37 in step S205. Then, the speech input device 100 returns to the state 1.

On the other hand, if No in step S204, the state determining unit 39 determines in step S207 whether the determination signal Sig_RD is at a high level (Sig_RD=H) and the level signal Sig_RL is at a level lower than the threshold level th6 (Sig_RL<th6), different from the state 3 in FIG. 13.

If Yes in step S207 (Sig_RD=H and Sig_DL<th6), the state determining unit 39 turns on the LED 50 via the LED driver 33 and initializes the timer 37 in step S205. Then, the speech input device 100 returns to the state 1. If No in step S207, the state determining unit 36 continues forced turn-off of the LED 50 in step S203.

In the flow chart of FIG. 17, steps S200, S201, S202 and S S206 require detection of the level of the determination signal Sig_RD for detection of the state 2 or 3, as described above. However, it is also preferable to detect the state 2 or 3 if a state of Sig_DL<th5 or Sig_DL≧th6 continues for a period that is deemed to be too long for the determination signal Sig_RD to maintain a high or low level, a period that is deemed to be too long for the determination signal Sig_RD to maintain a high or low level, thus turning off the LED 50, with no requirement of detection of the level of the signal Sig_RD.

In detail, as shown in FIG. 13, in the state 1, the level of the level difference Sig_DL becomes higher (or equal to) or lower than the threshold level th1 depending on a high or low level of the determination signal Sig_RD. On the other hand, in the state 2, the level of the level difference Sig_DL is always lower than the threshold level th5 irrespective of the level of the determination signal Sig_RD.

Therefore, it is also preferable to detect a period of the state of Sig_DL<th5 by the timer 37 and if the period measured by the timer 37 has passed a specific period Tm5, it is deemed that the current state is the state 2 in which the level difference Sig_DL does not follow the change in level of the determination signal Sig_RD (like the state 1), thus turning off the LED 50. The specific period Tm5 is set, for example, to five seconds, that is a period deemed to be too long for the determination signal Sig_RD to maintain a high level for which a speech segment continues.

Moreover, as shown in FIG. 13, in the state 3, the level of the level difference Sig_DL is always equal to or higher than the threshold level th6 irrespective of the level of the determination signal Sig_RD.

Therefore, it is also preferable to detect a period of the state of Sig_DL≧th6 by the timer 37 and if the period measured by the timer 37 has passed a specific period Tm6, it is deemed that the current state is the state 3 in which the level difference Sig_DL does not follow the change in level of the determination signal Sig_RD (like the state 1), thus turning off the LED 50. The specific period Tm6 is set, for example, to five seconds, that is a period deemed to be too long for the determination signal Sig_RD to maintain a low level for which a speech segment continues.

As described above in detail, equipped with the DSP 30b (FIG. 12), the speech input device 100 informs a user of the current sound pick-up state by detecting the pick-up states at both of the voice pick-up microphone 105 and the noise pick-up microphone 108.

In detail, as shown in (a) and (b) of FIG. 1, the voice pick-up microphone 105 and the noise pick-up microphone 108 are attached to the speech input device 100 on both sides of the main body 101. The is the typical arrangements of the voice and noise pick-up microphones for a wireless communication apparatus for professional use related to the present invention. Suppose that a user attaches the speech input device 100 to the user's chest or shoulder with the voice pick-up microphone 105 at the front side and the noise pick-up microphone 108 at the rear side so that microphone 108 touches or is covered by the user's clothes. In this case, it could happen that sounds do not reach the noise pick-up microphone 108 appropriately. In order to avoid such a problem, as described with reference to FIG. 15, an inappropriate sound pick-up state at the noise pick-up microphone 108 is detected and informed to the user, in the second modification. Then, the user can change the location of the speech input device 100 so that the noise pick-up microphone 108 can pick up sounds appropriately. When the microphone 108 picks up sounds appropriately, the speech input device 100 can suppress a noise component carried by the digital speech waveform signal Sig_V1 produced from the users' voice picked up by the voice pick-up microphone 105. This results in higher quality of a speech waveform signal transmitted from the wireless communication apparatus 900.

Moreover, as shown in (a) and (b) of FIG. 1, the voice pick-up microphone 105 and the noise pick-up microphone 108 are located close on both sides of the main body 101 of the speech input device 100. It could thus happen that a user's voice reaches the microphones 105 and 108 almost simultaneously, for example, when the user's mouth faces the side face of the main body 101 with the microphones 105 and 108 on the front and rear faces thereof, respectively. In this case, as described with reference to FIG. 16, it is detected that the user's voice is input to both of the microphones 105 and 108, and this state is informed to the user. Then, the user can change the location of the speech input device 100 so that the noise pick-up microphone 108 can pick up sounds appropriately. When the microphone 108 picks up sounds appropriately, the speech input device 100 can suppress a noise component carried by the digital speech waveform signal Sig_V1 produced from the users' voice picked up by the voice pick-up microphone 105. This results in higher quality of a speech waveform signal transmitted from the wireless communication apparatus 900.

It is further understood by those skilled in the art that the foregoing description is a preferred embodiment of the disclosed apparatus, device or method and that various changes and modifications may be made in the invention without departing from the sprit and scope thereof.

For example, the present invention may be applied to any apparatuses besides wireless communication apparatuses for professional use. The configuration of the digital signal processor (DSP) installed in the speech input device is not limited to those shown in FIGS. 3, 6 and 12.

The speech-segment determination and the filtering process in the speech input device are also not limited to those described above. In addition, the signal generator for generating a signal depending on the level of signal strength of the speech waveform signal Sig_V2 based on the sound picked up by the noise pick-up microphone 11 is not limited to the level difference detector 35 (FIG. 6) or the RMS converter 38 (FIG. 12). For, example, in FIG. 6, the state determining unit 36 may determine the sound pick-up state based on the output of the RMS converter 35b.

Informing a user of a sound pick-up state may not only done by the turn-on/off of the LED 50 (109) but also vibration, sounds, etc. Vibration may be generated in synchronism with user's speaking. Moreover, the LED 109 (50) may be configured to have two lighting elements to be turned on in two different colors. In this case, in FIG. 1, it is preferable that the LED 109 is turned on in a first color when the switch of the PIT unit 104 is depressed and switched to a second color when the current sound pick-up state is detected, and then turned off when the switch is released. The two-color LED indication is very effective because a user can visually know the voice pick-up state and the transmission state while the user is speaking.

Furthermore, a program running on a computer to achieve each of the embodiments and modifications described above is also embodied in the present invention. Such a program may be retrieved from a non-transitory computer readable storage medium or transferred over a network and installed in a computer.

As described above in detail, the present invention provides a speech input device, a speech input method and a speech input program, and a communication apparatus that inform a user of the current voice pick-up state.

What is claimed is:

1. A speech input device comprising:
a first sound pick-up unit configured to pick up a sound and outputting a first speech waveform signal based on the picked up sound;
a speech-segment determination unit configured to detect a speech segment corresponding to a voice input period during which a voice is input or a non-speech segment corresponding to a non-voice input period during which no voice is input, based on the first speech waveform signal and to output a determination signal that indicates whether the picked up sound is the speech segment or the non-speech segment; and
an indicating unit configured to indicate a detected state of the speech segment based on the determination signal.

2. The speech input device according to claim 1 further comprising:
a second sound pick-up unit configured to pick up a noise generated around a source of the sound and output a second speech waveform signal based on the picked up noise; and
a signal generating unit configured to generate an output signal depending on at least a level of signal strength of the second speech waveform signal,
wherein the indicating unit determines whether to continuously indicate the detected state of the speech segment, based on the determination signal and the output signal.

3. The speech input device according to claim 2, wherein the signal generating unit generates the output signal depending on a difference in level of signal strength of the first and second speech waveform signals.

4. The speech input device according to claim 1 further comprising:
a second sound pick-up unit for picking up a noise generated around a source of the sound and output a second speech waveform signal based on the picked noise; and
a signal generating unit configured to generate an output signal depending on at least a level of signal strength of the second speech waveform signal,
wherein the indicating unit compares a level of the output signal with a specific threshold level and stops the indication of the detected state of the speech segment if the comparison of the level of the output signal with the threshold level satisfies a specific requirement for a specific period.

5. The speech input device according to claim 4, wherein the signal generating unit generates the output signal depending on a difference in level of signal strength of the first and second speech waveform signals.

6. The speech input device according to claim 1 further comprising:
a second sound pick-up unit configured to pick up a noise generated around a source of the sound and output a second speech waveform signal based on the picked up noise;
a filter unit configured to perform a filtering process to the second speech waveform signal; and
a signal generating unit configured to generate an output signal depending on a level of signal strength of the second speech waveform signal subjected to the filtering process,
wherein the indicating unit determines whether to continuously indicate the detected state of the speech segment, based on the determination signal and the output signal.

7. The speech input device according to claim 6, wherein the filtering process depends on the determination signal.

8. The speech input device according to claim 1 further comprising:
a second sound pick-up unit configured to pick up a noise generated around a source of the sound and output a second speech waveform signal based on the picked up noise;
a filter unit configured to perform a filtering process to the second speech waveform signal; and
a signal generating unit configured to generate an output signal depending on a level of signal strength of the second speech waveform signal subjected to the filtering process,
wherein the indicating unit compares a level of the output signal with a specific threshold level and stops the indication of the detected state of the speech segment if the comparison of the level of the output signal with the threshold level satisfies a specific requirement for a specific period.

9. The speech input device according to claim 8, wherein the filtering process depends on the determination signal.

10. The speech input device according to claim 1, wherein the indicating unit has at least one lighting element to be turned on to indicate the detected state of the speech segment.

11. The speech input device according to claim 1 further comprising:
a first face and an opposing second face; and
a second sound pick-up unit configured to pick up a noise generated around a source of the sound,
wherein the first and second sound pick-up units are provided at the first and second faces, respectively.

12. A speech input method comprising the steps of:
picking up a sound;
generating a first speech waveform signal based on the picked up sound;
detecting a speech segment corresponding to a voice input period during which a voice is input or a non-speech segment corresponding to a non-voice input period during which no voice is input, based on the first waveform signal;
generating a determination signal that indicates whether the picked up sound is the speech segment or the non-speech segment; and
indicating a detected state of the speech segment based on the determination signal.

13. The speech input method according to claim 12 further comprising the steps of:
picking up a noise generated around a source of the sound;
generating a second speech waveform signal based on the picked up noise;
generating an output signal depending on at least a level of signal strength of the second speech waveform signal; and
determining whether to continuously indicate the detected state of the speech segment, based on the determination signal and the output signal.

14. The speech input method according to claim 12 further comprising the steps of:
picking up a noise generated around a source of the sound;
generating a second speech waveform signal based on the picked up noise;
generating an output signal depending on at least a level of signal strength of the second speech waveform signal;
comparing a level of the output signal with a specific threshold level; and
stopping the indication of the detected state of the speech segment if the comparison of the level of the output signal with the threshold level satisfies a specific requirement for a specific period.

15. A speech input program stored in a non-transitory computer readable storage medium, comprising:
a program code of picking up a sound;
a program code of generating a first speech waveform signal based on the picked up sound;
a program code of detecting a speech segment corresponding to a voice input period during which a voice is input or a non-speech segment corresponding to a non-voice input period during which no voice is input, based on the first speech waveform signal;
a program code of generating a determination signal that indicates whether the picked up sound is the speech segment or the non-speech segment; and
a program code of indicating a detected state of the speech segment based on the determination signal.

16. The speech input program according to claim 15 further comprising:
a program code of picking up a noise generated around a source of the sound;
a program code of generating a second speech waveform signal based on the picked up noise;
a program code of generating an output signal depending on at least a level of signal strength of the second speech waveform signal; and
a program code of determining whether to continuously indicate the detected state of the speech segment, based on the determination signal and the output signal.

17. The speech input program according to claim 15 further comprising:
a program code of picking up a noise generated around a source of the sound;
a program code of generating a second speech waveform signal based on the picked up noise;
generating an output signal depending on at least a level of signal strength of the second speech waveform signal;
a program code of comparing a level of the output signal with a specific threshold level; and
a program code of stopping the indication of the detected state of the speech segment if the comparison of the level of the output signal with the threshold level satisfies a specific requirement for a specific period.

18. A communication apparatus comprising:
a first sound pick-up unit configured to pick up a sound and outputting a speech waveform signal;
a transmission unit configured to transmit the speech waveform signal;
a speech-segment determination unit configured to detect a speech segment corresponding to a voice input period during which a voice is input or a non-speech segment corresponding to a non-voice input period during which no voice is input, based on the speech waveform signal and to output a determination signal that indicates whether the picked up sound is the speech segment or the non-speech segment; and
an indicating unit configured to indicate a detected state of the speech segment based on the determination signal.

19. The communication apparatus according to claim 18, wherein the indicating unit has at least one lighting element to be turned on to indicate the detected state of the speech segment.

20. The communication apparatus according to claim 18 further comprising:
a first face and an opposing second face; and
a second sound pick-up unit configured to pick up a noise generated around a source of the sound,
wherein the first and second sound pick-up units are provided at the first and second faces, respectively.
